(19) United States
(12) Patent Application Publication
(10) Pub. No.: US 2026/0228861 A1
(43) Pub. Date: Aug. 6, 2026

(54) METHODS AND SYSTEMS FOR RESTORATION AND DENOISING OF BIOLUMINESCENCE (BL) IMAGES

(71) Applicants: Alexander Klose, New York, NY (US); Neal Paragas, Seattle, WA (US)

(72) Inventors: Alexander Klose, New York, NY (US); Neal Paragas, Seattle, WA (US)

(21) Appl. No.: 19/182,015

(22) Filed: Apr. 17, 2025

Related U.S. Application Data
(60) Provisional application No. 63/635,577, filed on Apr. 17, 2024.

(51) Int. Cl. G06T 5/60; G06T 5/70

(52) U.S. Cl. CPC G06T 5/60; G06T 5/70; G06T 2207/10144; G06T 2207/20081; G06T 2207/20084; G06T 2207/30004; G06T 2207/30168

(57) ABSTRACT

In vivo Bioluminescence Imaging (BLI) is used for longitudinal studies in small animal models across various fields, such as cancer and neuroscience. DeepBLI addresses the challenges of low photon counts and noise, which requires sensitive cameras and lengthy integration times to achieve satisfactory Signal-To-Noise Ratios (SNR) and restore spatial light distribution. The Deep Learning (DL) tool is designed to address these issues by restoring and denoising BL images using synthetic training data generated from a Poisson-Gaussian Mixture model. This tool is particularly effective in enhancing images obtained under low-level light conditions, aiding applications like kinetic imaging (KI) and Bioluminescence Tomography (BLT). DeepBLI delivers robust performance and improvement over traditional image restoration methods, making it a significant advancement in BLI technology.

### FIELD OF THE INVENTION

The present invention relates to the field of bioluminescence imaging (BLI), particularly to a Deep Learning tool for restoration and denoising of bioluminescence (BL) images using synthetic training data.

### BACKGROUND OF THE INVENTION

Bioluminescence imaging (BLI) is a non-invasive technique utilized for longitudinal studies of biological processes in small animal models of human disease. Its applications span diverse fields such as cancer, infectious disease, neuroscience, gene expression, and stem cell research BLI relies on genetically engineered mice or labeled cells expressing light-emitting proteins (e.g., firefly luciferase) that act as reporters for the biological process under investigation. Upon administration of an exogenous substrate (e.g., luciferin), an enzymatic reaction induces the emission of light.

However, the detected photon count per unit time (light intensity) in bioluminescence (BL) images is relatively low, necessitating highly sensitive optical cameras and prolonged exposure times to achieve an acceptable signal-to-noise ratio (SNR). BL images are susceptible to various sources of noise, including signal-dependent photon shot noise due to the quantum nature of light and signal-independent dark and read noise arising from the sensor material and architecture.

Despite advancements in BLI instrumentation and image post-processing software, increasing SNR and restoring the original spatial light distribution remain significant challenges. Attempts to address these challenges result in longer and often unacceptable camera integration times and reduced image resolution due to pixel binning. Over the past decade, there has been limited progress in introducing new techniques to overcome these challenges. Most BLI instrumentation, such as the contemporary IVIS systems and the Lago systems continue to utilize cooled charged-coupled-device (CCD) cameras with similar optical performance, but without significant improvements in SNR or reduction in image acquisition time. While some basic image post-processing tools (e.g., Median filtering) have been employed to enhance SNR and improve image quality, their effectiveness under low-level light conditions is limited. Efforts for implementing advanced image restoration techniques have been completely neglected.

There is a pressing need to improve the SNR and restore the spatial light distribution in low-photon-count BL images, ultimately to reduce time required for image acquisition. In general, increasing imaging sensitivity or reducing camera integration time has already been a primary objective in many different imaging applications, such as in astro-imaging or fluorescence microscopy. Similarly, enhancing BL image quality or decreasing integration time is vital for researchers to visualize BL targets with low photon count effectively and more rapidly. These targets include, e.g., disseminated cancer cells, stem cells, metastasis, T cell immunotherapy, or bacterial distributions in infectious disease models. Addressing this unmet need not only unlocks novel avenues in BLI but also harbors the potential for transformative breakthroughs with far-reaching implications in biomedical research and clinical practice.

Enhancing the SNR and restoring the original spatial light distribution is crucial for improving image quality and enabling accurate analysis. The challenge lies in balancing the amplification of the BL signal (S) with the reduction of total noise (N). While augmenting the signal strength may seem impractical due to biological constraints (e.g., spectral limitations in photon emission of reporters), there are opportunities to mitigate various sources of noise: (i) Photon shot noise, a consequence of the stochastic nature of photon emission and detection, introduces variability in light intensity. (ii) Dark noise, stemming from sensor and detector electronics, manifests as spurious free electrons mimicking photon signals. (iii) Read noise, originating during the conversion of analog to digital signals, further exacerbates noise levels. (iv) Background noise, attributed to external factors like cosmic radiation or ambient light, poses additional challenges.

Classical noise models such as Poisson and Gaussian distributions provide a theoretical foundation for understanding these noise sources and guiding the development of traditional image post-processing techniques. For example, common strategies include Gaussian, Median, and Wiener filtering, which aim to attenuate high-frequency noise contributions while preserving essential image features like edges and larger structures. Deconvolution techniques offer a means of partially reversing image blurring induced noise, thereby enhancing SNR. Wavelet-based denoising decomposes images into frequency bands, allowing selective noise removal. Bayesian estimation methods leverage prior knowledge of image and noise statistics to estimate clean images from noisy observation.

Despite the advancements, the implementation of these techniques in BLI remains partial. Gaussian and Median filtering, while effective in modestly enhancing SNR, are often limited by their tendency to blur image structures or eliminate faint signals, such as metastases, captured under low-level light conditions. Thus, there exists a critical imperative to explore alternative methodologies capable of effectively mitigating noise while faithfully preserving or even restoring the original light distribution in BL images.

### SUMMARY OF THE INVENTION

DeepBLI, as disclosed herein, introduces a novel approach utilizing Deep Learning (DL) for image restoration and denoising in BLI. Departing from conventional post-processing methods, DeepBLI preferably employs multi-layered neural networks to predict noise-reduced images from their noise-corrupted counterparts. To overcome the challenge of limited availability of noise-free ground-truth images in BLI, DeepBLI preferably utilizes synthetic training data generated based on a Poisson-Gaussian Mixture model. Ground truth images are created using a digital mouse model and a numerical light propagation model, paired with noise-corrupted images incorporating a mixture of Poisson and Gaussian noise. Alternatively, long-exposure images (ground truth) could be paired with short-exposure images (noisy counterpart) yielding a similar training data set or augment the existing synthetic training data sets based on the Poisson-Gaussian Mixture model. The trained U-Net architecture effectively restores and denoises BL images obtained under extreme low-level light emission scenarios, such as disseminated cancer or T cells.

In vivo Bioluminescence Imaging (BLI) is a non-invasive technique for longitudinal studies in small animal models, utilized across diverse fields such as cancer, T cell immunotherapy, infectious disease, neuroscience, and stem cell research. However, BL images suffer from low photon counts and various noise sources, necessitating sensitive cameras and prolonged integration times, leading to challenges in achieving satisfactory Signal-To-Noise Ratios (SNR) and restoring spatial light distribution. Traditional image post-processing methods offer limited effectiveness in enhancing SNR without compromising image resolution. To address these challenges, the present application provides DeepBLI, a Deep Learning (DL) solution for image restoration and denoising in BLI. DeepBLI utilizes multi-layered neural networks trained on synthetic data generated using a Poisson-Gaussian Mixture model, overcoming the scarcity of ground-truth images in BLI. By effectively restoring images obtained under extreme low-level light conditions, DeepBLI enhances imaging quality, facilitating applications like kinetic imaging (KI) and Bioluminescence Tomography (BLT) that require rapid acquisition of sequential BL images with low photon counts. DeepBLI represents a significant advancement in BLI technology, promising robust performance and transcending traditional image restoration methods. In addition, DeepBLI can also be applied to surgical optical imaging and surgical intervention using optical probes and markers.

The innovation disclosed herein is directed to a method for restoring and denoising bioluminescence images (BL). The method may include the step of designing a neural network model for predicting noise-reduced images from noise-corrupted counterparts and establishing a training dataset of image pairs including a plurality of ground truth images and a plurality of corresponding noise corrupted images. In one embodiment, a synthetic training dataset may be generated based on image pairs including the plurality of ground truth images and the plurality of corresponding noise corrupted images. The method may further include training the neural network on the synthetic training dataset and predicting, using the neural network model trained on the synthetic training dataset, a noise reduced image from a noise reduced counterpart. In one embodiment, the neural network is a convolutional neural network. For example, the convolutional neural network may include a U-Net architecture. The U-Net architecture may include an encoder, a decoder and a plurality of direct connections between the encoder and decoder. According to one embodiment, the plurality of ground truth images are generated with a digital mouse model. Additionally the plurality of ground truth images may also be generated with a light propagation model. In some embodiments, the plurality of corresponding noise corrupted images include a plurality of contributions from a mixture of photon shot noise, dark noise and read noise. The step of generating a synthetic training dataset based on starting training dataset of image pairs may include utilizing a Poisson-Gaussian mixture model with a plurality of contributions calibrated to achieve an independently adjustable peak signal to noise ratio. Furthermore, the method may include, optimizing the contribution of the Poisson-Gaussian Mixture model for one or more Gaussian noise parameters through a target mean square error of the peak signal to noise ratio. Additionally, the method may further include optimizing the contribution of the Poisson-Gaussian Mixture model for one or more Poisson noise parameters through iteratively seeking a target peak signal to noise ratio.

The method for restoring and denoising bioluminescence images (BL), comprising: designing a neural network model for predicting noise-reduced images from noise-corrupted counterparts; establishing a starting dataset with a plurality of experimental image pairs including a plurality of ground truth images and a plurality of corresponding noise corrupted images; generating a synthetic training dataset based on starting dataset of experimental image pairs; augmenting the synthetic training dataset with the starting dataset with the plurality of experimental image pairs; training the neural network on the synthetic training dataset; predicting, using the neural network model trained on the synthetic training dataset, a noise reduced image from a noise reduced counterpart.

Alternatively, the training data set based on synthetic image data could be augmented with real-world experimental image data obtained from imaging experiments. Specifically, such ground truth images are obtained from a set of long-exposure images and paired with short-exposure images representing the noisy counterparts.

In one embodiment, a computer readable medium comprising program code that when executed by a processor, causes a computing device to design a neural network model for predicting noise-reduced images from noise-corrupted counterparts and establish a starting training dataset of image pairs including a plurality of ground truth images and a plurality of corresponding noise corrupted images. The computer readable medium may further include program code that will generate a synthetic training dataset based on starting training dataset of image pairs including the plurality of ground truth images and the plurality of corresponding noise corrupted images as well as train the neural network on the synthetic training dataset. Additionally, the computer readable medium may, in one example, predict, using the neural network model trained on the synthetic training dataset, a noise reduced image from a noise reduced counterpart

In one embodiment, the neural network is a convolutional neural network. For example, the convolutional neural network may be comprised of a U-Net architecture. In some embodiments, the U-Net architecture includes an encoder, a decoder and a plurality of direct connections between the encoder and decoder. The plurality of ground truth images are generated with a digital mouse model and/or a light propagation model. In one embodiment, the plurality of corresponding noise corrupted images include a plurality of contributions from a mixture of photon shot noise, dark noise and read noise. The program code may include further instructions that allow the step of generating a synthetic training dataset based on starting training dataset of image pairs to include utilizing a Poisson-Gaussian mixture model with a plurality of contributions calibrated to achieve an independently adjustable peak signal to noise ratio. The program code may include further instructions to optimize the contribution of the Poisson-Gaussian Mixture model for one or more Gaussian noise parameters through a target mean square error of the peak signal to noise ratio. In one embodiment, the computer code may optimize the contribution of the Poisson-Gaussian Mixture model for one or more Poisson noise parameters through iteratively seeking a target peak signal to noise ratio.

### BRIEF DESCRIPTION OF THE DRAWINGS

FIG. 1 illustrates a panel of luminescence images of a tissue phantom with three light sources.

FIG. 2 illustrates a schematic of proposed image restoration method according to one embodiment.

FIG. 3 illustrates a schematic of how DeepBLI restores a noise corrupted synthetic image.

FIG. 4. illustrates a pixel-wise Pearson correlation between images in FIG. 3 and ground truth.

FIG. 5 illustrates a schematic of how DeepBLI restores phantom images with low integration time.

FIG. 6 illustrates a pixel-wise Pearson correlation between images in FIG. 5 and the ground truth.

FIG. 7 illustrates a plurality of graphs of pixel-wise correlations.

### DETAILED DESCRIPTION

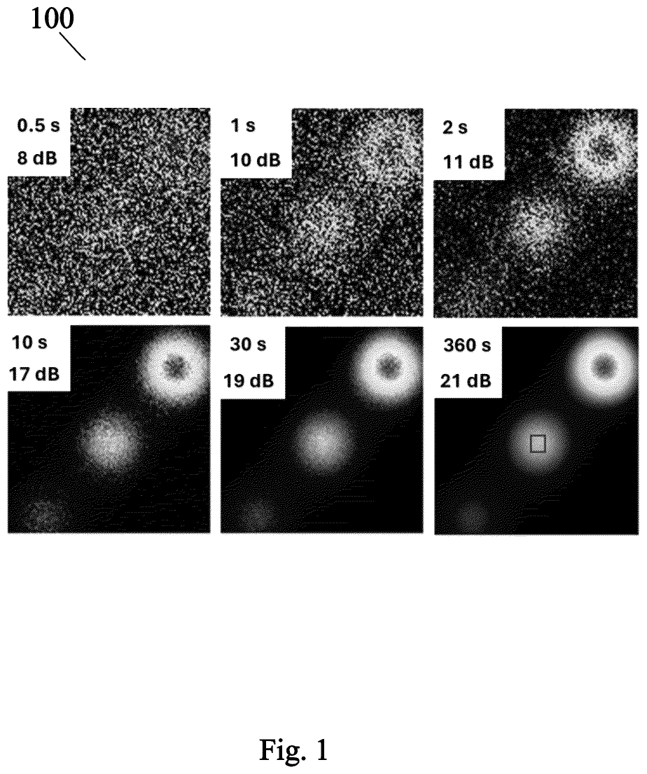

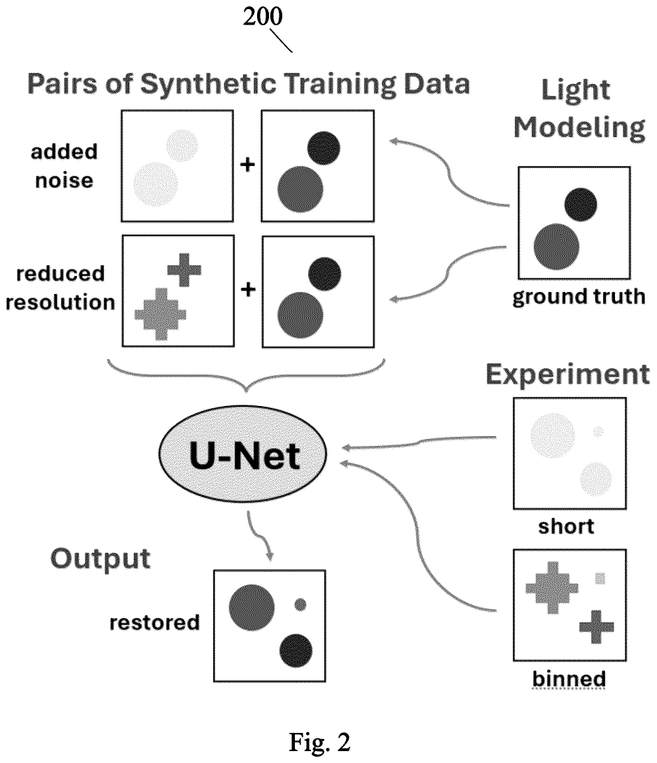

Going beyond traditional image post-processing methods of noise-corrupted images (FIG. 1), the solution(s) disclosed herein leverage Deep Learning (DL) for image restoration and denoising in BLI (FIG. 2). Unlike traditional image post-processing tools, DL methods do not rely on specific noise models but instead utilize neural networks to predict noise-reduced images from their noise-corrupted counterparts acquired during imaging experiments. The DL network may be trained with datasets comprising pairs of noise-free (ground truth) and noise-corrupted images. While DL has demonstrated promising results in astronomical imaging, nuclear imaging, and fluorescence microscopy, its application in BLI faces challenges due to the absence of training data pairing perfectly noise-free BL images with their corrupted equivalents. To address this challenge, the present application provides a method for generating synthetic training data based on a Poisson-Gaussian Mixture model without the need for experimental data.

A set of “ground truth” images depicting the light distribution on the animal's surface may be generated using a digital mouse model and a light propagation model accounting for light scattering and absorption in tissue, while using random configurations of light sources inside tissue. This model may be based on the Simplified Spherical Harmonics (SP_{N}) equations which provide a high-order transport solution and can be applied to small tissue volumes and large tissue absorption, thus ensuring a high level of quantification accuracy. This ground truth set is paired with a noise-corrupted set, incorporating a mixture of Poisson and Gaussian noise. Both noise models encapsulate contributions from photon shot noise (Poisson), dark noise (Gaussian), and read noise (Gaussian), albeit without requiring precise knowledge of noise component contributions.

A U-Net model may be trained using these synthetic image pairs, which becomes proficient in predicting light distribution on the animal's surface at full image resolution while using noisy and pixel-binned BL images as input. The input images can be obtained under challenging low-level light conditions such as from sources like metastatic or disseminated cancer, bacteria and viruses, or immune and stem cells. This approach promises to overcome the limitations of inherent training data scarcity (i.e., missing noise-free BL images for providing the ground truth dataset), paving the way for robust image restoration and denoising in BLI. The U-Net Architecture may be embodied in a convolutional neural network (CNN) with an encoder-decoder structure. The encoder progressively downsamples the input image, capturing contextual features. The decoder upsamples the feature maps to reconstruct the output image. Skip connections between corresponding encoder and decoder layers help preserve spatial details and enhance learning stability. The training dataset of the U-Net model can either exist of synthetic image pairs or of experimental image pairs, or a combination of both. In addition, one dataset could augment the other dataset. One embodiment is that the synthetic dataset augments the experimental data set.

Alternatively, other models may be employed, including but not limited to Residual Networks (ResNet); Residual Dense Networks (RDN); Transformers such as Swin Transformer for Image Restoration (SwinIR); Restormer; Attention U-Net; Pixel Shuffle Networks such as Efficient Sub-Pixel, CNN (ESPCN), Enhanced Deep SR (EDSR) and Generative Adversarial Networks (GANs).

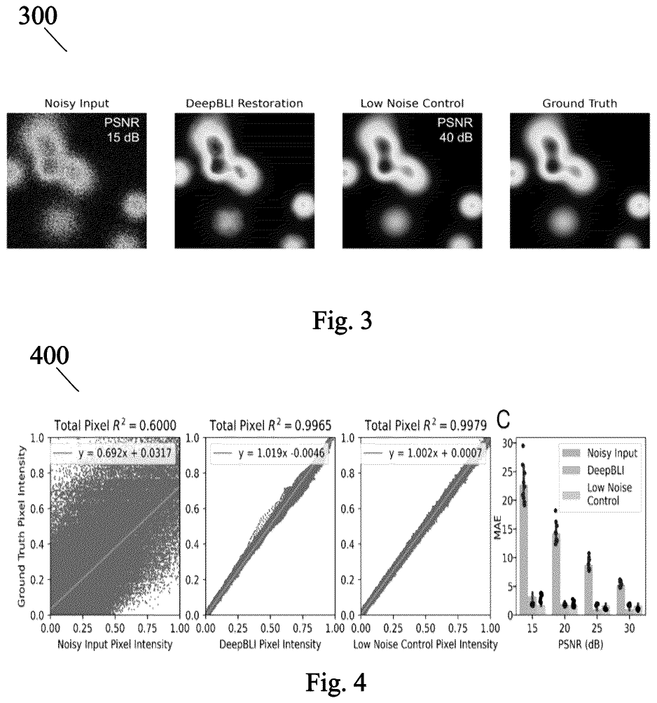

Drawing from the success of Deep Learning (DL) tools in restoring and denoising fluorescence microscopy images, the present application explores the application of DL methods in bioluminescence (BL) image restoration under low-light conditions (FIG. 3). Initially, synthetic image data was generated to mimic experimental BLI conditions using a Poisson-Gaussian-Mixture model to represent major noise contributions. Subsequently, the feasibility of applying a U-Net model under controlled conditions was investigated, utilizing synthetic training datasets. The application of DL to experimental image data was then demonstrated through an illustrative example. The initial simulation study employed a noise model for synthetic BL image generation, a U-Net architecture, synthetic training data, and a basic phantom experiment, providing promising evidence that bioluminescence sources could be effectively restored under low-light conditions encountered in BLI of small animals.

For synthetic BL image generation, 10 diffuse light sources with Gaussian spread σ ranging from 10 to 96 pixels and brightness from 50% to full saturation within a 480×480 pixel canvas were stochastically created. Noise was introduced using signal-dependent Poisson (photon shot) and signal-independent Gaussian (dark and read) noise, each calibrated to achieve independently adjustable Peak Signal-to-Noise Ratios (PSNR) ranging from 15 to 25 dB. Gaussian noise parameters were derived from the desired PSNR's mean square error (MSE), while Poisson noise was generated iteratively to meet the target PSNR.

Training, validation, and testing datasets were generated, comprising 200 image pairs each for the testing and validation sets, with the training set consisting of 1000 ground truths. A standard four-level U-Net model architecture was utilized for image restoration, optimized through Mean Squared Error (MSE) loss with evaluation metrics including mean absolute error (MAE), Structural Similarity Index Measure (SSIM), and Pearson's correlation coefficient (R2). The model was trained with a learning rate starting at 1×10−4, halving if no validation MSE improvement occurred over five epochs, until the lowest MSE was achieved.

Validation on synthetic datasets demonstrated DeepBLI's ability to effectively denoise images with a PSNR of 15 dB to a quality comparable to a control image with a PSNR of 40 dB. Pixel-wise comparison revealed high correlation coefficients, indicating accurate restoration of noise-corrupted images. Testing on short exposure images from a real imaging setup showed a significant increase in image quality, suggesting a near 50-fold reduction in imaging time while maintaining signal integrity. Focused analyses on Regions of Interest (ROIs) revealed DeepBLI's enhancements varied with signal-dependent noise, achieving significant reductions in imaging time while maintaining quality, thereby demonstrating the efficacy of the invention in BL image restoration and denoising.

In general, a training dataset for DeepBLI may include a plurality of paired images: (1) noisy image and (2) noise-free ground truth. These images can either be obtained from an imaging experiment, where a camera takes images of an optical phantom and at different exposure times. For example, the short exposure camera images provides the noisy image, whereas the long exposure image provides the ground truth. Our proposed technique refrains to calculated or synthetic image pairs, where a statistical model simulates the noise. In other words, our technique can obtain images for the training dataset on the fly by leveraging the use of a physically correct noise model.

Although the methods may be discussed herein with reference to BLI images, it is understood that the novel techniques disclosed herein are applicable to machine learning of all types of imaging in which there may be limited availability of noise-free ground-truth images for use in training a model, including fluorescence imaging, tomographic imaging, Cherenkov luminescence imaging, optical imaging, including for optical image-guided surgery, such as fluorescence-guided surgery, and fluorescence-guided robotic surgery, NIR optical imaging, such as tomographic screening of breast cancer, contrast-enhanced optical imaging, optical imaging of endogenous contrast, and the like, and is therefore not limited to BLI type imaging.

FIG. 1 illustrates a panel 100 of luminescence images of a tissue phantom with three light sources. Taken with an IVIS Spectrum (Revvity) at different camera integration times (seconds). SNR (decibel) shown for image center (red box).

FIG. 2 illustrates a schematic 200 of proposed image restoration method according to one embodiment. DeepBLI, using a U-Net and synthetic training data consisting of pairs of low-resolution and noisy images. Experimental input data consists of pixel-binned images taken with short camera integration times. According to one embodiment, a U-Net may be described as network comprising a contracting path (left side) and an expansive path (right side). The contracting path may follow the typical architecture of a convolutional network. In one embodiment, the contracting path may include the repeated application of two 3×3 convolutions (unpadded convolutions), each followed by a rectified linear unit (ReLU) and a 2×2 max pooling operation with stride 2 for downsampling. At each downsampling step, one may double the number of feature channels. Every step in the expansive path may include an upsampling of the feature map followed by a 2×2 convolution (“up-convolution”) that halves the number of feature channels, a concatenation with the correspondingly cropped feature map from the contracting path, and two 3×3 convolutions, each followed by a ReLU. The cropping is necessary due to the loss of border pixels in every convolution. At the final layer a 1×1 convolution is used to map each 64-component feature vector to the desired number of classes. In total, the network may include 23 convolutional layers.

Synthetic data may be understood as artificially generated data that mimics real-world data. In this context, synthetic data may be comprised of input-output pairs where the input is a degraded version of an image (e.g. noisy, blurry, low-res). The output may be a clean, high-quality ground truth image. This noisy data may generated using known degradation models like noise addition (e.g., Gaussian, Poisson, salt-and-pepper), Blurring (Gaussian blur, motion blur), Downsampling (bicubic, bilinear interpolation) and/or Compression artifacts (JPEG, etc.). In some embodiments, there may be a disconnect between synthetic to real transfer. For example, models trained only on synthetic data may struggle on real-world images if real degradations differ from simulated ones. Options for these situations include the use of one or more of the following techniques a) domain adaptation or fine-tuning on real samples; b) adding more realistic synthetic degradations (e.g., camera-specific noise profiles) and c) combining with unsupervised or self-supervised learning.

FIG. 3 illustrates a schematic 300 of how DeepBLI restores a noise-corrupted synthetic image. From left to right, noisy input image at 15 dB PSNR (Poisson 18 dB and Gaussian 18 dB), its DeepBLI restoration, low noise control at 40 dB PSNR, and ground truth. Ten diffuse light sources with Gaussian spread σ ranging from 10 to 96 pixels and brightness from 50% to full saturation within a 480×480 pixel canvas were stochastically created, termed Ground-Truth image (far right image). Signal-dependent Poisson (photon shot) and signal-independent Gaussian (dark and read) noise was added to the Ground-Truth image yielding a Noise-Corrupted image (far left image), while each source is calibrated to achieve independently adjustable Peak Signal-to-Noise Ratios (PSNR). The noise-corrupted image example became input to the DeepBLI image restoration scheme based on a U-Net model, which subsequently restored a “noise-free” source distribution (second image to the left). The restored DeepBLI image exhibits close similarities to the Ground-Truth image (far right image) and a mildly noise-corrupted image (second image to the right). This example demonstrates the utility of the DeepBLI for restoring a “noise-free” bioluminescence image using a noise-corrupted image as input and in the absence of a Ground-Truth. It promises to significantly shorten image acquisition times and reduces image noise.

FIG. 4. illustrates a pixel-wise Pearson correlation (R²) 400 between images in FIG. 3 (from far left to right: noisy input, DeepBLI prediction, low-noise control) and its ground truth. MAE in relation to varying PSNR (far right) for noisy input, low noise control, and DeepBLI prediction (n=10 images). To assess DeepBLI's ability to restore noise corrupted image data, we performed a pixel-wise comparison of the noise-corrupted input, the DeepBLI restored, and the low-noise control images to the ground truth image. A comparison of the Pearson's correlation coefficients R² revealed that the noisy image had the lowest R² of only 0.6000, while DeepBLI's restoration achieved an R² of 0.9965, closely matching the low noise control's R² of 0.9979. This results underline the significance of DeepBLI's image restoration performance when using noise-corrupted images as input. Extending this analysis on additional noise corrupted images with varying levels of PSNR (15, 20, 25, and 30 dB) demonstrated DeepBLI reduced the MAE (chart far right) to a level comparable to low noise controls

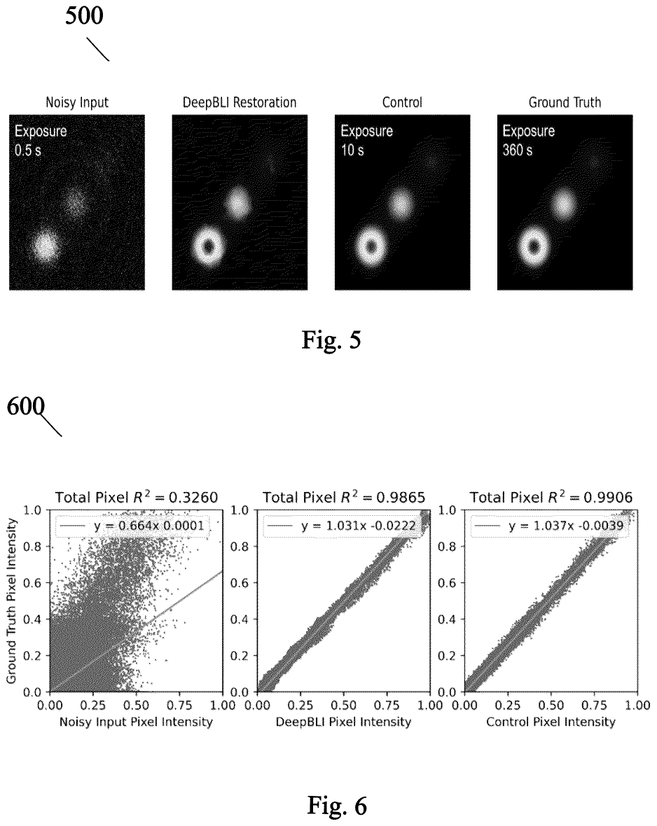

FIG. 5 illustrates a schematic 500 of how DeepBLI restores images in an experimental setting using an optical phantom with multiple light sources of varying noise levels. Camera images have been taken with different integration times (0.5, 10, and 360 seconds). The short-exposure image (0.5 seconds exposure time) served as input to DeepBLI. In comparison, from left to right: noisy input at 0.5 seconds exposure, DeepBLI restoration of previous, control image at 10 seconds exposure, and ground truth at 360 seconds long exposure. This experimental example demonstrates the DeepBLI's ability for restoring real-world images with significant noise levels and significantly reducing camera integration time while maintaining signal integrity. DeepBLI transformed a 0.5 second exposure image into one of significantly higher quality similar to the ground truth image (360 seconds exposure time).

FIG. 6 illustrates a pixel-wise Pearson correlation 600 between images in FIG. 5 and the ground truth. It demonstrates the significance of DeepBLI's ability for reducing the camera integration time in an experimental setting. Pearson correlation coefficients of R²=0.3260 to 0.9865, closely approaching the control based on a 10 second exposure with an R²=0.9906, suggest a near 50-fold reduction in imaging time.

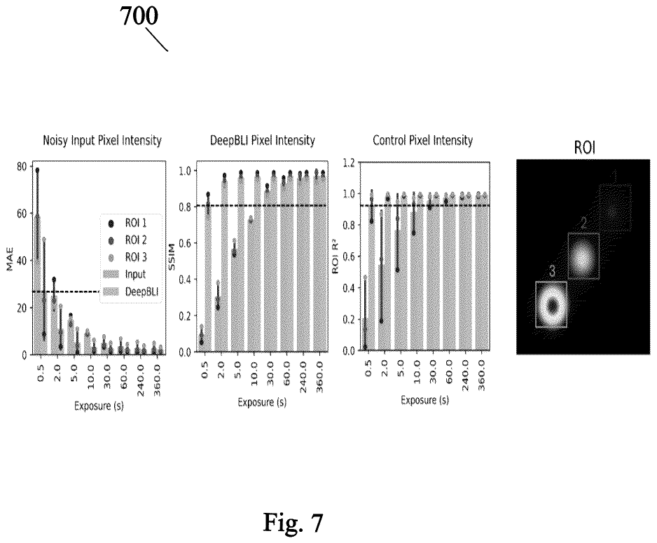

FIG. 7 illustrates a plurality of graphs 700 of pixel-wise correlations. More specifically, the graphs illustrate pixel-wise comparisons for noisy input, low noise control, and DeepBLI prediction to the ground truth at different camera exposure times. The ground truth image (far right) shows n=3 region-of-interests (ROIs) with different sources and light intensity levels (ROI)From left to right: MAE, SSIM, ROI R², and ground truth image with ROIs. Given the critical role of ROIs in numerous BLI applications, focused analysis on ROIs of varying signal intensities revealed that DeepBLI enhancements varied with signal-dependent noise, achieving an average MAE akin to only 2 seconds exposure time and similarity measures (SSIM and R²) on par with 10 to 30 seconds exposure times, suggesting a 4 to 60-fold decrease in total imaging time.

While the foregoing invention has been described in some detail for purposes of clarity and understanding, it will be appreciated by one skilled in the art, from a reading of the disclosure, that various changes in form and detail can be made without departing from the true scope of the invention.

1. A method for restoring and denoising bioluminescence images (BL), comprising:
designing a neural network model for predicting noise-reduced images from noise-corrupted counterparts;
establishing a starting dataset with a plurality of experimental image pairs including a plurality of ground truth images and a plurality of corresponding noise corrupted images;
augmenting a synthetic training dataset with the starting dataset with the plurality of experimental image pairs;
training the neural network on the synthetic training dataset;
predicting, using the neural network model trained on the synthetic training dataset, a noise reduced image from a noise reduced counterpart.

2. The method of claim 1, wherein the neural network is a convolutional neural network and wherein the plurality of ground truth images includes a plurality of long exposure images and the plurality of noise corrupted images includes a plurality of corresponding short exposure images.

3. The method of claim 2, wherein the convolutional neural network is a U-Net architecture.

4. The method of claim 3, wherein the U-Net architecture includes an encoder, a decoder and a plurality of direct connections between the encoder and decoder.

5. The method of claim 1, wherein the plurality of ground truth images are generated with a digital mouse model.

6. The method of claim 5, wherein the plurality of ground truth images are generated with a light propagation model.

7. The method of claim 1, wherein the plurality of corresponding noise corrupted images include a plurality of contributions from a mixture of photon shot noise, dark noise and read noise.

8. The method of claim 1, wherein the step of generating a synthetic training dataset based on starting training dataset of image pairs includes utilizing a Poisson-Gaussian mixture model with a plurality of contributions calibrated to achieve an independently adjustable peak signal to noise ratio.

9. The method of claim 8, further comprising:
optimizing the contribution of the Poisson-Gaussian Mixture model for one or more Gaussian noise parameters through a target mean square error of the peak signal to noise ratio.

10. The method of claim 8, further comprising:
optimizing the contribution of the Poisson-Gaussian Mixture model for one or more Poisson noise parameters through iteratively seeking a target peak signal to noise ratio.

11. A computer readable medium comprising program code that when executed by a processor, causes a computing device to:
design a neural network model for predicting noise-reduced images from noise-corrupted counterparts;
establish a starting dataset with a plurality of experimental image pairs including a plurality of ground truth images and a plurality of corresponding noise corrupted images;
augment a synthetic training dataset with the starting dataset with the plurality of experimental image pairs;
train the neural network on the synthetic training dataset;
predict, using the neural network model trained on the synthetic training dataset, a noise reduced image from a noise reduced counterpart.

12. The computer readable medium of claim 11, wherein the neural network is a convolutional neural network wherein the plurality of ground truth images includes a plurality of long exposure images and the plurality of noise corrupted images includes a plurality of corresponding short exposure images.

13. The computer readable medium of claim 12, wherein the convolutional neural network is a U-Net architecture.

14. The computer readable medium of claim 13, wherein the U-Net architecture includes an encoder, a decoder and a plurality of direct connections between the encoder and decoder.

15. The computer readable medium of claim 11, wherein the plurality of ground truth images are generated with a digital mouse model.

16. The computer readable medium of claim 15, wherein the plurality of ground truth images are generated with a light propagation model.

17. The computer readable medium of claim 11, wherein the plurality of corresponding noise corrupted images include a plurality of contributions from a mixture of photon shot noise, dark noise and read noise.

18. The computer readable medium of claim 11, wherein the step of generating a synthetic training dataset based on starting training dataset of image pairs includes utilizing a Poisson-Gaussian mixture model with a plurality of contributions calibrated to achieve an independently adjustable peak signal to noise ratio.

19. The computer readable medium of claim 18, further comprising computer code that when executed by the processor, causes the computing device to:
optimize the contribution of the Poisson-Gaussian Mixture model for one or more Gaussian noise parameters through a target mean square error of the peak signal to noise ratio.

20. The computer readable medium of claim 18, further comprising computer code that when executed by the processor, causes the computing device to:
optimize the contribution of the Poisson-Gaussian Mixture model for one or more Poisson noise parameters through iteratively seeking a target peak signal to noise ratio.
